(19) United States
(12) Patent Application Publication
(10) Pub. No.: US 2018/0327109 A1
(43) Pub. Date: Nov. 15, 2018

(54) PROPULSION UNIT COMPRISING A MAIN ENGINE AND AN AUXILIARY ENGINE

(71) Applicant: SAFRAN AIRCRAFT ENGINES, Paris (FR)

(72) Inventors: Pascal Charles Edouard COAT, Moissy-Cramayel (FR); Jean-François Endy BERSOT, Moissy-Cramayel (FR); Stephane ORCEL, Moissy-Cramayel (FR); Nicolas Jerome Jean TANTOT, Moissy-Cramayel (FR)

(73) Assignee: SAFRAN AIRCRAFT ENGINES, Paris (FR)

(21) Appl. No.: 15/776,433

(22) PCT Filed: Nov. 16, 2016
(86) PCT No.: PCT/FR2016/052979

§ 371 Date: May 16, 2018

(30) Foreign Application Priority Data
Nov. 16, 2015 (FR) 1561001
Nov. 16, 2015 (FR) 1561005
Nov. 16, 2015 (FR) 1561008
Nov. 16, 2015 (FR) 1561011
Nov. 16, 2015 (FR) 1561012

(51) Int. Cl. B64D 41/00; B64D 27/16; F02K 3/06

(52) U.S. Cl. CPC B64D 41/00; F05D 2220/323; F02K 3/06; B64D 27/16

(57) ABSTRACT

A propulsion unit for an aircraft is provided. The propulsion unit includes a main engine that supplies main thrust during a takeoff operating condition and a top of climb operating condition, and an auxiliary engine, distinct from the main engine, that supplies auxiliary thrust to complete the main thrust of the main engine during the takeoff operating condition. The main engine includes a high-pressure compressor. The main engine is dimensioned taking into account the thrust of the auxiliary engine in the takeoff operating condition, in such a manner that a temperature ratio of the high-pressure compressor, corresponding to the ratio between an outlet temperature of the high-pressure compressor of the main engine in the top of climb operating condition and an outlet temperature of the high-pressure compressor of the main engine in the takeoff operating condition, is between 0.90 and 1.10.

### FIELD OF THE INVENTION

The invention relates to the general field of aircraft, and more particularly to the dimensioning of the engines of such aircraft for the purpose of improving, among others, their specific fuel consumption. The invention finds application in all types of aircraft designed to accomplish missions including diverse operating conditions.

### TECHNOLOGICAL BACKGROUND

In operation, an engine is loaded differently depending on the phases of flight of the aircraft. In fact, each flight phase is associated with an operating condition of the engine, including ground idle, takeoff, climb, top of climb or maximum climb, or cruise. During the aforementioned operating conditions, the engine is held during a relatively long time (between thirty seconds for takeoff and several hours for cruise) at predefined speed spectra which depend on the redline of the engine (namely the maximum absolute speed encountered by the low-pressure shaft during the entire flight).

The operating condition of the engine that is most constraining in terms of thrust is takeoff. That is why, customarily, engines for aircraft are dimensioned depending on this operating condition so as to guarantee their capacity to cause the aircraft to take off. For this purpose, the engines are dimensioned so as to function at maximum temperatures at combustion chamber inlet and outlet during the takeoff phase, in order for the thermodynamic cycle (and therefore energetic) efficiency of the engine to be optimal during this phase. These inlet and outlet temperatures of the combustion chamber with therefore directly condition the size of the high-pressure portions of the engine (high-pressure compressor, combustion chamber and high-pressure turbine) as well as their constitutive material, so that they are capable of providing the thrust necessary for takeoff.

However, the duration of the takeoff phase is very short (between one and five minutes approximately, depending on the type of aircraft and their mission) compared with other phases of flight. The result is that, during the major portion of the flight, the engine requires a smaller thrust and therefore has a smaller thermodynamic (and therefore energetic) efficiency. This is the case in particular in the cruise operating condition, which generally lasts at least thirty minutes. In fact, during cruise, the power required by the engine is smaller than during takeoff. Now the reduction in the power of the engine is obtained by reducing the outlet temperature of the combustion chamber and therefore at the high-pressure turbine inlet of the engine, which involves a reduction of the overall compression ratio. The result is that, during this flight phase, the specific fuel consumption of the engine is higher than its optimum.

Now currently, so as to satisfy growing regulatory constraints (in terms of acoustics and pollutant emissions in particular) and to reduce the costs of operation of the engines, particularly connected to their specific fuel consumption, engine manufacturers have a tendency to increase the inlet and outlet temperatures of combustion chambers so as to reduce the size of the high-pressure body of the engines and increase the size of the low-pressure body while still maintaining fan diameters acceptable to the aircraft manufacturers. Such a temperature increase at the inlet and outlet of the combustion chamber also allows an improvement in the efficiency of the thermodynamic cycle of the engines, in that the overall compression ratio and the temperature at the high-pressure turbine inlet increase. This indeed improves the thermodynamic efficiency during the takeoff phase, which is the sizing phase. However, the thermodynamic efficiency in the other flight phases is not optimal, particularly in the cruise operating condition.

Engine manufacturers therefore try to achieve a compromise between the needs of the engine depending on the different operating conditions and the impact of these constraints in terms of specific fuel consumption, mass, acoustic constraints, etc.

### SUMMARY OF THE INVENTION

One objective of the invention is therefore to propose a solution in the field of aircraft propulsion which responds to this problem set of reconciling operational constraints, such as the capacity of the propulsion unit to allow an aircraft to take off, with ambitious fuel consumption objectives typical of civil commercial aviation.

For this purpose, the invention proposes a propulsion unit for an aircraft, said propulsion unit being configured to supply takeoff thrust during a takeoff operating condition and top of climb thrust during a top of climb operating condition and comprising:
at least one main engine, configured to supply main thrust during the takeoff operating condition and the top of climb operating condition, said main engine comprising a high-pressure compressor, and
at least one auxiliary engine, distinct from the main engine and configured to supply auxiliary thrust so as to complete the main thrust of the engine during at least the takeoff operating condition.

Moreover, the main engine is dimensioned by taking into account the thrust of the auxiliary engine in the takeoff operating condition, in such a manner that a temperature ratio of the high-pressure compressor, corresponding to the ratio between an outlet temperature of the high-pressure compressor of the main engine in the top of climb operating condition and an outlet temperature of the high-pressure compressor of the main engine in the takeoff operating condition is comprised between 0.90 and 1.10, for example between 0.95 and 1.05.

Independently or in combination, the main engine can comprise a ducted fan which has an inlet section, said fan being situated upstream of the high-pressure compressor in the gas flow direction in the main engine. A normalized main engine fan flow rate ratio, corresponding to the ratio between the normalized air flow rate entering the fan of the main engine at the inlet section in the top of climb operating condition and the normalized air flow rate entering the main engine fan at said inlet section in the takeoff operating condition, can be comprised between 1.3 and 1.50, preferably between 1.35 and 1.40.

Also independently or in combination, the main engine can have a ratio comprised between 1.50 and 1.90, for example between 1.55 and 1.80, between its overall compression ratio in the top of climb operating condition and its overall compression ratio of the main engine in the takeoff operating condition.

Also independently or in combination with the preceding features, the main engine can also comprise a combustion chamber extending downstream of the high-pressure compressor in the direction of gas flow in the main engine. The main engine can then have temperature ratio (corresponding to the ratio between, on the one hand, a ratio between an outlet temperature of the combustion chamber of the main engine in the top of climb operating condition and an outlet temperature of the combustion chamber of the main engine in the takeoff operating condition and, on the other hand, the temperature ratio of the high-pressure compressor) comprised between 1.00 and 1.10.

Also independently or in combination, the main engine can have a body size ratio (corresponding to the ratio between a body size at an inlet section of the high-pressure compressor of the main engine in the top of climb operating condition and the body size at said inlet section of the high-pressure compressor of the main engine in the takeoff operating condition) comprised between 0.95 and 1.05.

Still independently or in combination, the main engine can comprise, downstream of the fan in the gas flow direction, a combustion chamber, and a ratio between an outlet temperature of the combustion chamber of the main engine in the top of climb operating condition and an outlet temperature of the combustion chamber of the main engine in the takeoff operating condition can then be comprised between 0.90 and 1.10, for example between 1.00 and 1.05.

Also independently or in combination, the main engine can comprise a high-pressure turbine downstream of the high-pressure compressor in the gas flow direction, with a ratio between an outlet temperature of the high-pressure turbine of the main engine in the top of climb operating condition and an outlet temperature of the high-pressure compressor of the main engine in the takeoff operating condition which is comprised between 0.90 and 1.10, for example between 0.95 and 1.05.

Also independently or in combination, the auxiliary engine comprises a ducted fan having an inlet section, with a normalized flow rate ratio of the fan of the auxiliary engine, corresponding to the ratio between the normalized air flow rate entering the fan of the auxiliary engine at the inlet section in the top of climb operating condition and the normalized air flow rate entering the fan of the auxiliary engine at said inlet section in the takeoff operating condition, comprised between 1.00 and 1.10.

Also independently or in combination, a ratio between an overall compression ratio of the auxiliary engine in the top of climb operating mode and an overall compression ratio of the auxiliary engine in the takeoff operating condition can be comprised between 1.00 and 1.30.

Finally, the propulsion unit can, in a non-limiting manner, comprise at least two auxiliary engines, the thrust of said auxiliary engines participating at the level of 100% of the auxiliary thrust.

### BRIEF DESCRIPTION OF THE DRAWINGS

Other features, aims and advantages of the present invention will appear more clearly upon reading the detailed description which follows, and with reference to the appended drawings given by way of non-limiting examples and in which:

FIG. 1 is a graph illustrating, for several parameters, the ratio between the value of this parameter measured for an operating condition corresponding to the top of climb and the value of this parameter measured for an operating condition corresponding to takeoff, for an embodiment of a main engine of a propulsion unit conforming to the invention and for a conventional engine,

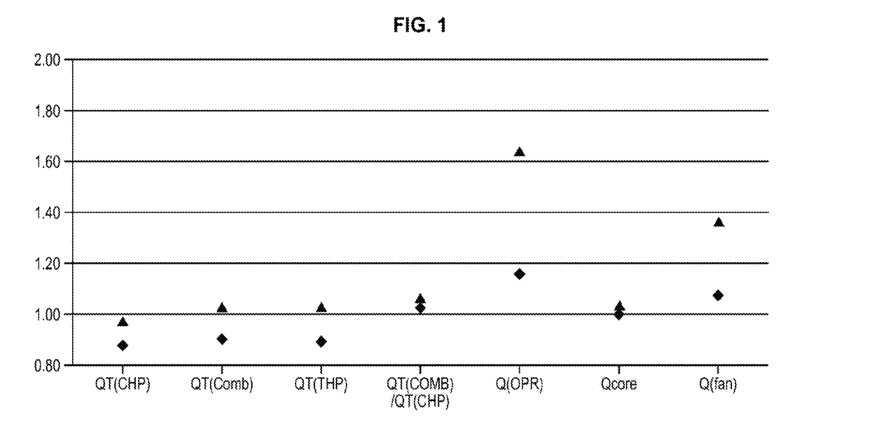

FIG. 2 illustrates an exemplary embodiment of an aircraft which can comprise a propulsion unit conforming to the invention, and

FIG. 3 is a schematic partial section view of an exemplary embodiment of a main engine.

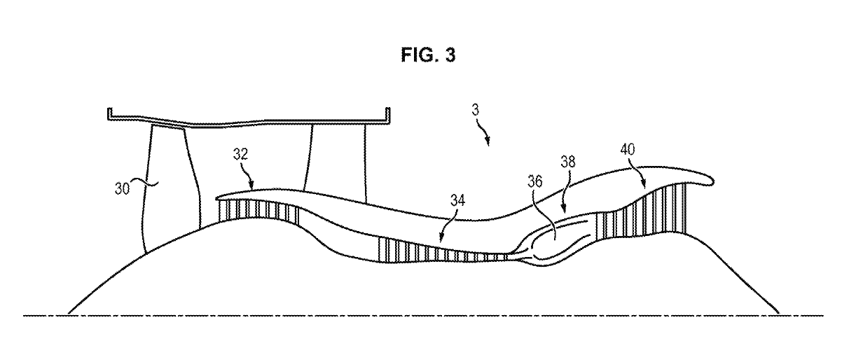

### DETAILED DESCRIPTION OF ONE EMBODIMENT

In order to improve the specific fuel consumption of a propulsion unit 2 for an aircraft 1 comprising a main engine 3, the invention proposes freeing the main engine 3 from the constraint of being capable of supplying sufficient thrust to cause the aircraft 1 to take off and to add to the propulsion unit 2 an auxiliary engine 4, distinct from the main engine 3, in order to compensate the loss of thrust linked to this modification of the main engine 3. It then becomes possible to dimension the main engine 3 so as to significantly improve its specific fuel consumption in the flight phases having a considerable duration, such as cruise, while still guaranteeing that the propulsion unit 2 is capable of causing the aircraft 1 to take off.

For this purpose, the propulsion unit 2 is configured to operate at two distinct operating conditions at least and comprises at least one main engine 3 and one auxiliary engine 4. These two engines contribute to the total thrust delivered by the propulsion unit, in different proportions of thrust according to the flight phases. What is meant here and in the entire present text by a main engine is an engine configured to supply thrust during all the different flight phases, and in particular to supply, during the cruise phase, thrust which contributes principally to the total thrust. What is meant by an auxiliary engine is an engine which assists the main engine by supplying auxiliary thrust during certain flight phases (during the takeoff phase and until top of climb in particular). Preferably, the auxiliary engine is cut during flight phases requiring a smaller total thrust, such as the cruise phase; it can also, during these phases, operate at idle or at low thrust.

Hereafter, the invention will be described more particularly in the case where the main engine 3 comprises a turbojet. This is not limiting, however, the main engine(s) 3 being able to comprise one or more turbojets and/or one or more turboprops, said main engines 3 being able to comprise at least one fan/propeller, ducted or not ducted.

In a manner known in itself, the turbojet 3 therefore comprises, from upstream to downstream in the gas flow direction in the turbojet 3, at least one ducted fan 30 housed in a fan 30 casing, a primary flow annular space and a secondary flow annular space. The mass of air aspired by the fan 30 is therefore divided into a primary flow, which circulates in the primary flow space, and a secondary flow, which is concentric with the primary flow and circulates in the secondary flow space.

The primary flow space passes through a primary body comprising one or more compressor stages, for example a low-pressure compressor 32 and a high-pressure compressor 34, a combustion chamber 36, one or more turbine stages, for example a high-pressure turbine 38 and a low-pressure turbine 40, and a gas exhaust nozzle.

Depending on the flight phases, the main engine 3 and the auxiliary engine 4 supply together the thrust of the propulsion unit. In particular, the main engine 3 can be assisted by the auxiliary engine 4 during the takeoff phase so as to supply the takeoff thrust to the propulsion unit 2 and possibly during the top of climb phase so as to supply the top of climb thrust. For example, the thrust supplied by the propulsion unit 2 during the takeoff phase can be obtained at the level of 5% to 45% by the auxiliary engine 4, the remainder being contributed by the main engine 3. In the top of climb phase, the main engine 3 can supply all the required thrust, or be assisted at the level of 0% to 50% by the auxiliary engine 4.

Typically, for an engine having a rotation speed redline of the low-pressure portions comprised between 3000 rpm (revolutions per minute) and 4000 rpm, takeoff corresponds to a rotation speed of the low-pressure shaft comprised between 2500 and 3000 rpm, while the top of climb corresponds to a rotation speed of the low-pressure shaft comprised between 3000 rpm and 3500 rpm. Furthermore, the propulsion unit can have additional operating conditions, such as among others cruise, idle (on the ground and in flight), etc.

It will be noted that the distribution of thrust between the main engine 3 and the auxiliary engine 4 of the propulsion unit 2 can be determined depending on the function of the aircraft type 1 and on the associated type of mission (short, medium, long haul, etc.). Typically, for an aircraft 1 configured to carry out a mission of the long haul type, the portion of the thrust supplied by the auxiliary engine 4 at the top of climb is preferably greater than in the case of an aircraft 1 configured to carry out a mission of the short haul type. In fact, the flight time in the cruise operating condition is shorter in a short haul than in a long haul, so that it can be preferably to improve the thermodynamic efficiency of the propulsion unit 2 at top of climb and to limit the bulk and the weight of the auxiliary engine 4 rather than improving its thermodynamic efficiency in cruise and increasing the bulk and the weight of the auxiliary engine 4.

The auxiliary engine 4 can supply thrust continuously between the operating condition corresponding to takeoff and the operating condition corresponding to top of climb, or as a variant be stopped during one or more of said regimes.

In order to reduce the specific fuel consumption of the propulsion unit 2 while guaranteeing the capacity of the propulsion unit 2 to cause the aircraft 1 to take off, the main engine 3 is dimensioned so that a temperature ratio of the high-pressure compressor QT_{CHP} is comprised between 0.90 and 1.10, for example between 0.95 and 1.05. This relation is valid regardless of the type of the main engine 3 (one or more turbojet(s) and/or turboprop(s)).

With respect to the temperature of the high-pressure compressor QT_{CHP}, it will be understood here that this is the ratio between the outlet temperature of the high-pressure compressor 34 (and therefore at the inlet of the combustion chamber 36) of the main engine 3 in the top of climb operating condition T_{CHP(ToC)} and an outlet temperature of the high-pressure compressor 34 of the main engine during the takeoff operating condition T_{CHP(TkOff)}. The temperature at the outlet of the high-pressure compressor T_{CHP} represents the temperature of the fluid leaving the diffuser, which itself is placed behind the last movable wheel of the high-pressure compressor 34.

By way of comparison, for a conventional engine (that is an engine dimensioned based on the takeoff operating condition and which does not have an auxiliary engine), the temperature ratio QT_{CHP} is generally comprised between 0.85 and 0.95. It is deduced from this that the outlet temperature T_{CHP} of the high-pressure compressor 34 at top of climb is higher in the main engine than in the conventional engine. The main engine 3 is dimensioned so as to have little variation of compressor outlet T_{CHP}, between the takeoff condition and the top of climb condition, with respect to a conventional engine without auxiliary thrust during takeoff. The compression ratio of the high-pressure compressor 34 is therefore higher for the main engine 3 at top of climb, which constitutes a benefit in terms of thermal efficiency of the turbojet(s)/turboprop(s) of the main engine 3.

In an engine of the turbojet type, the pressure of the air leaving the high-pressure compressor 34 is the highest in the engine. The result is that the high-pressure compressor 34 cannot be cooled because none of the other components is capable of supplying it with sufficiently pressurized air for ventilating it. The outlet temperature of the high-pressure compressor 34 is therefore an optimization point of this compressor. By dimensioning the main engine 3 so that the temperature T_{CHP(Toc)} at top of climb is greater than the temperature T_{CHP(TkOff)} at takeoff, it is thus possible to optimize the thermodynamic cycle of the main engine 3 during the top of climb or cruise operating condition, instead of having a compromise between the optimizations in the top of climb operating condition and the takeoff operating condition, and to improve the specific fuel consumption of the main engine 3. It will be noted that, knowing the optimum temperature T_{CHP} to be expected at the outlet of the high-pressure compressor 34, it is then possible to define an optimal form of the blading of each stage of the high-pressure compressor 34, associated with a materials technology.

In the case where the main engine 3 comprises at least one turbojet, a normalized fan flow rate ratio Q_{fan} of the main engine 3 can be comprised between 1.30 and 1.50. With respect to the normalized fan flow rate Q_{fan} of the main engine 3, what is meant here is the ratio between the normalized flow rate of air entering the fan 30 of the main engine at the inlet section in the top of climb operating condition and the normalized flow rate of air entering the fan 30 of the main engine 3 at said inlet section in the takeoff operating condition. The normalized flow rate Q_{fan} corresponds here to the mass flow rate of air at the inlet of the fan Qm_{fan} and normalized with the total pressure and temperature conditions at the inlet of the fan in conformity with the following formula:

$${Q}_{fan} = {Qm}_{fan} \times \sqrt{\frac{{T}_{fan}}{{T}_{std}} / \frac{{P}_{fan}}{{P}_{std}}}$$

where:
Qm_{fan} corresponds to the total mass flow rate of air at the inlet section of the fan
T_{fan} corresponds to the temperature at the inlet section of the fan (expressed in Kelvin, K)
T_{std} corresponds to the standard temperature (288.15 K)
P_{fan} corresponds to the pressure at the inlet section of the fan (expressed in Bar)
P_{std} corresponds to the standard pressure (1.0135 Bar)

The inlet section of the fan 30, where the air flow rate Qm_{fan}, the temperature T_{fan} and the pressure P_{fan} are measured, corresponds to the surface of the fan casing 30 seen by the flow which enters into said fan 30, in a plane perpendicular to an axis of revolution of the fan 30. It will be noted that the exact position of the measurement of this inlet section is not critical in that a flow rate ratio is evaluated, as long as the flow rate is determined for the same inlet section of the fan 30 in the takeoff operating condition and in the tip of climb operating condition.

To calculate this ratio Q_{fan}, the normalized air flow rate in the top of climb operating condition and in the takeoff operating condition is measured when the main engine 3 is stationary in a standard atmosphere (as defined by the manual of the International Civil Aviation Organization (ICAO), Doc 7488/3, 3^{rd} edition) and at sea level.

A main engine 3 comprising a turbojet having such a normalized fan flow rate ratio Q_{fan} then has a better specific fuel consumption compared with a conventional engine because it is dimensioned, not according to a compromise between the takeoff operating condition and the cruise condition, but mainly according to the top of climb and cruise operating condition, which corresponds to a substantial portion of the operation of the main engine 3. The normalized air flow ratio Q_{fan} at the inlet of the fan 30 of the main engine 3 is therefore greater at the top of climb than at takeoff while, for a conventional engine, the normalized fan flow rate ratio Q_{fan} is situated between 1.00 and 1.10. The result is that a main engine 3 conforming to the invention has a more efficient thermodynamic cycle than a conventional engine.

In one embodiment, the ratio between the total pressure of the fan 30 of the main engine 3 can be comprised between 1.35 and 1.40.

The ratio Q_{OPR} between the overall compression ratio of the main engine 3 in the top of climb operating condition and the overall compression ratio of the main engine 3 in the takeoff operating condition can be comprised between 1.50 and 1.90, for example between 1.55 and 1.80. This relation is valid regardless of the type of main engine 3 (one or more turbojet(s) and/or turboprop(s)).

By way of comparison, for a conventional engine, this ratio is customarily comprised between 1.00 and 1.30. This difference is explained by the fact that the assistance of the auxiliary engine 4 allow the thermodynamic operation of the main engine 3 to be optimized by selecting by design to have it operate for all operating conditions (takeoff, top of climb, cruise, idle, etc.) at temperatures and pressures hear the maximum allowed by the nature of the materials and components of its modules. This makes it possible in particular to increase the compression ratio in the low-pressure and high-pressure compressors of the main engine 3.

By overall compression ratio is meant here the combination of the compression ratio of the high-pressure compressor 34, the low-pressure compressor 32 and of the fan 30 or, in other words, the ratio between the outlet pressure of the high-pressure compression (and therefore the inlet of the combustion chamber 36) and the pressure at the inlet of the fan 30. The overall compression ratio is determined, whether in the top of climb operating condition or in the takeoff operating condition, when the main engine 3 is stationary in a standard atmosphere (as defined by the manual of the International Civil Aviation Organization (ICAO), Doc 7488/3, 3_{rd} edition) and at sea level.

The temperature ratio QT_{comb}, corresponding to the ratio between the outlet temperature of the combustion chamber 36 (and therefore at the inlet of the high-pressure turbine) of the main engine 3 in the top of climb operating condition T_{Comb(Toc)} and the outlet temperature of the combustion chamber 36 of the main engine 3 in the takeoff operating condition T_{Comb(TkOff)} can be comprised between 0.90 and 1.10, for example between 0.95 and 1.05. This relation is valid regardless of the type of the main engine 3 (one or more turbojet(s) and/or turboprop(s)).

By way of comparison, for a conventional engine, the temperature ratio QT_{Comb} is generally comprised between 0.85 and 0.95. It is deduced that the temperature T_{Comb} at the outlet of the combustion chamber 36 at top of climb is higher in the main engine 3 than in a conventional engine. The thermodynamic cycle of the turbojet of the main engine 3 is therefore more efficient.

In an engine of the turbojet type, the high-pressure turbine 38 is generally cooled by ventilation. The dimensioning of the cooling system is generally achieved based on maximum temperature conditions encountered at the takeoff condition, and the cooling system is over-dimensioned and under-used for other operating conditions. The temperature ratio QT_{Comb} thus defined allows the constant use of the cooling system of the high-pressure turbine 38 of the main engine 3 on its optimum of operation, and therefore of cooling effectiveness. In addition, the limitation of thermal excursions seen by the high-pressure turbine 38 between the takeoff and cruise conditions contributes to limiting mechanical deterioration of the latter and therefore to improving its lifetime.

A high pressure temperature ratio QT_{Comb}/QT_{CHP}, corresponding to the ratio between, on the one hand, the ratio between the outlet temperature of the combustion chamber 36 of the main engine 3 in the top of climb operating condition T_{Comb(Toc)} and the outlet temperature of the combustion chamber 36 of the main engine 3 in the takeoff operating condition T_{Comb(TkOff)}, and, on the other hand, the ratio QT_{CHP} between the outlet temperature of the high-pressure compressor 34 of the main engine 3 in the top of climb operating condition T_{CHP(ToC)} and an outlet temperature of the high-pressure compressor 34 of the main engine 3 in the takeoff operating condition T_{CHP(TkOff)}, can be comprised between 1.00 and 1.10.

In other words, the high pressure temperature ratio QT_{Comb}/QT_{CHP} corresponds to the ratio between the temperature ratio QT_{comb} and the temperature ratio QT_{CHP}.

This relation is valid regardless of the type of main engine 3 (one or more turbojet(s) and/or turboprop(s)).

It will therefore be understood that here, the main engine 3 is not a variable-cycle engine, because its high pressure temperature ratio QT_{Comb}/QT_{CHP} is substantially equal to that of a conventional engine regardless of its operating conditions.

The temperature ratio QT_{THP}, which corresponds to the ratio between the outlet temperature of the high-pressure turbine 38 (and therefore of the inlet of the low-pressure turbine 40) of the main engine 3 in the top of climb operating condition T_{THP(Toc)} and the outlet temperature of the high-pressure turbine 38 of the main engine 3 in the takeoff operating condition T_{THP(TkOff)} can be comprised between 0.90 and 1.10, for example between 0.95 and 1.05. The outlet temperature of the high-pressure turbine T_{THP} can, for example, be measured in a zone near the last mobile wheel of the high-pressure turbine 38 (at the leading edge of the first stator of the low-pressure turbine 40 or at the pressure surface wall of the second stator of the low pressure turbine 40). This relation is valid regardless of the type of main engine 3 (one or more turbojet(s) and/or turboprop(s)).

By way of comparison, for a conventional engine, the temperature ratio QT_{THP} is generally comprised between 0.85 and 0.95. It is deduced that the outlet temperature of the low-pressure turbine 40 at top of climb is higher in the main engine 3 than in a conventional engine.

The inlet temperature of the low-pressure turbine 40 is an optimization point of the low-pressure turbine 40 and of the main engine 3 in general. The selection of outlet temperature of the high-pressure turbine 30 in the top of climb operating condition T_{THP(Toc)} thus allows the main engine 3 to be dimensioned for the top of climb or cruise operating condition, which cover a substantial portion of the operation of the main engine 3, and not exclusively for the takeoff operating condition. The limitation of the thermal excursions seen by the low-pressure turbine 40 between the takeoff and cruise conditions contributes to limit the mechanical deterioration of the latter and therefore to improving its lifetime.

A body size ratio Q_{core} of the main engine 3 between the top of climb and takeoff operating conditions can be comprised between 0.95 and 1.05. This relation is valid regardless of the type of main engine 3 (one or more turbojet(s) and/or turboprop(s)).

By body size ratio Q_{core} of the main engine 3 is meant here the ration between the body size at an inlet section of the high-pressure compressor 34 of the main engine 3 in the top of climb operating condition and the body size at said inlet section in the takeoff operating condition.

The body size T_{core} corresponds here to the mass flow of air Qm_{core} entering into the high-pressure compressor 34 of the main engine 3 at the inlet section corrected for conditions of total temperature T_{CHP} and pressure P_{CHP} at the outlet of the high-pressure compressor 34 in conformity with the following formula:

$${T}_{core} = {Qm}_{core} \times \frac{\sqrt{\frac{{T}_{CHP}}{{T}_{std}}}}{\frac{{P}_{CHP}}{{P}_{std}}}$$

where:
Qm_{CHP} corresponds to the total mass flow of air at the inlet of the fan
T_{CHP} corresponds to the outlet temperature of the high-pressure compressor 34 (expressed in Kelvin, K)
T_{std} corresponds to the standard temperature (288.15 K)
P_{CHP} corresponds to the outlet pressure of the high-pressure compressor 34 (expressed in Bar)
P_{std} corresponds to the standard pressure (1.0135 Bar)

Here too, the body size T_{core} in the top of climb operating condition and in the takeoff operating condition is measured when the main engine 3 is stationary in a standard atmosphere (as defined by the manual of the International Civil Aviation Organization (ICAO), Doc 7488/3, 3^{rd} edition) and at sea level.

The body size T_{core} is representative of the geometric height of the stream of the high-pressure compressor 34.

The auxiliary engine 4 can also be dimensioned so as to optimize the specific fuel consumption of the propulsion unit 2. Typically, when the auxiliary engine 4 comprises one or more turbojets including, conventionally, a ducted fan 30, a fan flow rate ratio Q_{fan} of the auxiliary engine 4 can be comprised between 1.00 and 1.10.

Analogously to the fan flow rate ratio Q_{fan} of the main engine 3 defined above, the fan flow rate ratio Q_{fan} of the auxiliary engine 4 then corresponds to the ratio between the flow rate of air entering into the fan 30 of the auxiliary engine 4 at the inlet section in top of climb operating conditions and the flow rate of air entering into the fan 30 of the auxiliary engine 4 at said inlet section in takeoff operating conditions, the flow rate being measured when the auxiliary engine 4 is stationary in a standard (as defined by the manual of the International Civil Aviation Organization (ICAO), Doc 7488/3, 3^{rd} edition) and at sea level.

As a variant, the auxiliary engine(s) 4 can comprise one or more turboprops and/or or more propulsion actuators driven by electric engines. According to another variant, the auxiliary engine(s) can comprise one or more turbojets in combination with one or more turboprops and/or one or more propulsion actuators driven by electric engines.

Furthermore, the ratio Q_{OPR} between the overall compression ratio of the auxiliary engine 4 in the top of climb operating condition and the overall compression ratio of the auxiliary engine 4 in the takeoff operating condition can be comprised between 1.00 and 1.30.

Here again, the overall compression ratio in the top of climb operating condition and in the takeoff operating condition is measured when the auxiliary engine 4 is stationary in a standard atmosphere (as defined by the manual of the International Civil Aviation Organization (ICAO), Doc 7488/3, 3^{rd} edition) and at sea level.

A body size ratio Q_{core} of the auxiliary engine 4 between the top of climb and takeoff operating conditions can be comprised between 0.95 and 1.05.

With respect to the body size Q_{core} of the auxiliary engine 4, what is meant here is the ratio between the size of the body at an inlet section of the high-pressure compressor 34 of the auxiliary engine 4 in the top of climb operating condition and the body size at said inlet section in the takeoff operating condition.

The definition and the measurement of the body size T_{core} indicated for the main engine 3 apply, mutatis mutandis, to the auxiliary engine 4.

The propulsion unit 2 can comprise one or more main engines 3 and one or more auxiliary engines 4. In this case, the main engine(s) 3 then participate together in supplying the main thrust, while the auxiliary engine(s) 4 participate together in supplying the auxiliary thrust.

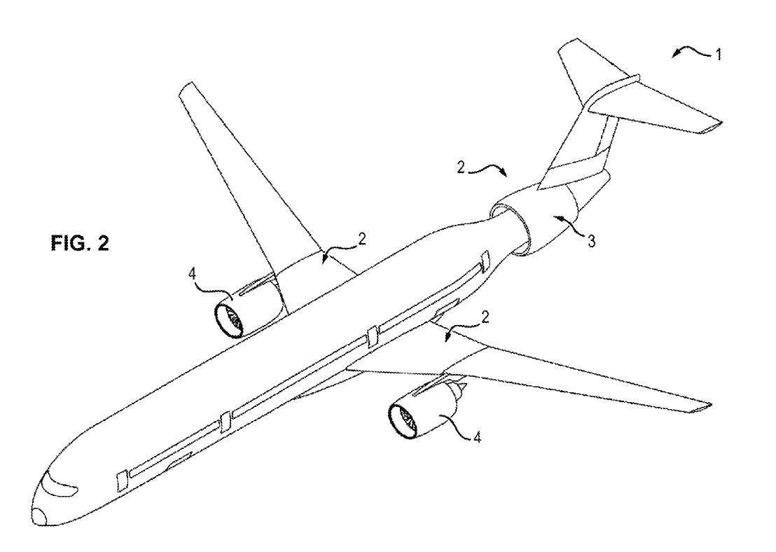

For example, the propulsion unit 2 can comprise a main engine 3 and two auxiliary engines 4. The auxiliary engines 4 can be example be attached below the wings of an aircraft 1 while the main engine 3 can be placed at the rear of the fuselage of the aircraft 1, as illustrated in FIG. 2.

Typically, the propulsion assembly 2 can comprise a turboprop with a non-ducted fan and two auxiliary engines 4 each comprising one or more actuators driven by an electric engine.

If appropriate, the auxiliary engine(s) can be retractable, i.e. their position can be modified during certain flight phases of the aircraft 1 so as to reduce their drag. For example, the auxiliary engines 4 can be retracted by being withdrawn into a specific well formed in the wings of the aircraft 1.

1. A propulsion unit for an aircraft, said propulsion unit being configured to supply takeoff thrust in a takeoff operating condition and a top of climb thrust during a top of climb operating condition and comprising:
at least one main engine, configured to supply main thrust during the takeoff operating condition and the top of climb operating condition, and
at least one auxiliary engine, distinct from the main engine and configured to supply auxiliary thrust so as to complete the main thrust of the main engine during at least the takeoff operating condition,
wherein:
the main engine comprises a high-pressure compressor, and
the main engine is dimensioned taking into account the thrust of the auxiliary engine in the takeoff operating condition, in such a manner that a temperature ratio of the high-pressure compressor, corresponding to the ratio between an outlet temperature of the high-pressure compressor of the main engine in the top of climb operating condition and an outlet temperature of the high-pressure compressor of the main engine in the takeoff operating condition, is comprised between 0.90 and 1.10.

2. The propulsion unit according to claim 1, wherein:
the main engine also comprises a ducted fan which has an inlet section, said fan being situated upstream of the high-pressure compressor in the gas flow direction in the main engine, and
a normalized fan flow rate ratio of the main engine, corresponding to the ratio between the normalized air flow rate entering the fan of the main engine at the inlet section in the top of climb operating condition and the normalized flow rate of air entering the fan of the main engine at said inlet section in the takeoff operating condition is comprised between 1.3 and 1.50.

3. The propulsion unit according to claim 1, in which a ratio between an overall compression ratio of the main engine in the top of climb operating condition and an overall compression ratio of the main engine in a takeoff operating condition, is comprised between 1.50 and 1.90.

4. The propulsion unit according to claim 1, wherein:
the main engine also comprise a combustion chamber extending downstream from the high-pressure compressor in the gas flow direction in the main engine and
a temperature ratio of the main engine, corresponding to the ratio between, on the one hand, a ratio between an outlet temperature of the combustion chamber of the main engine in the top of climb operating condition and an outlet temperature of the combustion chamber of the main engine in the takeoff operating condition, and, on the other hand, the temperature ratio of the high-pressure compressor, is comprised between 1.00 and 1.10.

5. The propulsion unit according to claim 1, wherein a body size ratio of the main engine, corresponding to the ratio between a body size at an inlet section of the high-pressure compressor of the main engine in the top of climb operating condition and the body size at said inlet section of the high-pressure compressor of the main engine in the takeoff operating condition, is comprised between 0.95 and 1.05.

6. The propulsion unit according to one claim 1, wherein:
the main engine also comprises, downstream from the fan, a combustion chamber in the gas flow direction in the main engine, and
a ratio between an outlet temperature of the combustion chamber of the main engine in the top of climb operating condition and an outlet temperature of the combustion chamber in the takeoff operating condition is comprised between 0.90 and 1.10.

7. The propulsion unit according to claim 1, wherein:
the main engine also comprises, downstream of the high-pressure compressor in the gas flow direction in the main engine, a high-pressure turbine and
a ratio between an outlet temperature of the high-pressure turbine of the main engine in the top of climb operating condition and an outlet temperature of the high-pressure turbine of the main engine in the takeoff operating condition is comprised between 0.90 and 1.10.

8. The propulsion unit according to claim 1, wherein the auxiliary engine comprises a ducted fan having an inlet section, and wherein a normalized fan flow rate ratio of the auxiliary engine, corresponding to the ratio between the normalized air flow rate entering the fan of the auxiliary engine at the inlet section in the top of climb operating condition and the normalized flow rate of air entering the fan of the auxiliary engine at said inlet section in the takeoff operating condition is comprised between 1.00 and 1.10.

9. The propulsion unit according to claim 1, wherein a ratio between an overall compression ratio of the auxiliary engine in the top of climb operating condition and an overall compression ratio of the auxiliary engine in the takeoff operating condition is comprised between 1.00 and 1.30.

10. The propulsion unit according to claim 1, comprising at least two auxiliary engines, the thrust of said auxiliary engines participating at the level of 100% of the auxiliary thrust.

11. The propulsion unit according to claim 1, wherein the temperature ratio of the high-pressure compressor is between 0.95 and 1.05.

12. The propulsion unit according to claim 2, wherein the inlet section in the takeoff operating condition is comprised between 1.35 and 1.40.

13. The propulsion unit according to claim 3, wherein the ratio between the overall compression ratio of the main engine in the top of climb operating condition and the overall compression ratio of the main engine in a takeoff operating condition is between 1.55 and 1.80.

14. The propulsion unit according to claim 6, wherein the body size ratio of the main engine is comprised between 1.00 and 1.05

15. The propulsion unit according to claim 7, wherein the ratio between an outlet temperature of the high-pressure turbine of the main engine in the top of climb operating condition and the outlet temperature of the high-pressure turbine of the main engine in the takeoff operating condition is comprised between 0.95 and 1.05.
